(19) United States
(12) Patent Application Publication
(10) Pub. No.: US 2025/0390660 A1
(43) Pub. Date: Dec. 25, 2025

(54) MULTI DIE CONFIGURABLE CLOCK NETWORKS

(71) Applicant: XILINX, INC., San Jose, CA (US)

(72) Inventors: Brian C. GAIDE, Erie, CO (US); Chirag RAVISHANKAR, Erie, CO (US); Abhijit RAY, San Jose, CA (US); Hui LI, San Jose, CA (US)

(21) Appl. No.: 18/749,406

(22) Filed: Jun. 20, 2024

(51) Int. Cl. G06F 30/396; G06F 30/3947; G06F 119/12

(52) U.S. Cl. CPC G06F 30/396; G06F 30/3947; G06F 2119/12

(57) ABSTRACT

An electronic device includes a plurality of integrated circuits (ICs), each IC comprising an array of resources, and a regional clock circuitry comprising horizontal routing tracks located on each horizontal edge of each of the resources, and vertical routing tracks located on each vertical edge of each of the resources, and a global clock circuitry formed using the horizontal routing tracks and the vertical routing tracks. At least one pair of the horizontal routing tracks located on horizontal IC interface circuitries or the vertical routing tracks located on vertical IC interface circuitries of at least two adjacent ICs of the plurality of ICs are tied together and the global clock circuitry is configured to route a clock signal to each of the plurality of ICs.

### TECHNICAL FIELD

An embodiment relates to configurable clock circuitries of integrated circuit (IC) devices. More particularly, an embodiment relates to an architecture for configurable global and regional clock circuitries of ICs.

### BACKGROUND

Clock circuitries of integrated circuits (ICs), such as Field Programmable Gate Arrays (FPGAs) for example, have used regional and global clocks. Conventionally, such regional clocks were driven only from an “edge” of such ICs, and such global clocks were driven only from the center of such ICs. This type of clock circuitry architecture was considerably inflexible. However, as ICs became larger, clock skew and/or clock delay, as well as increased timing uncertainty, became more of an issue, and such inflexibility made addressing one or more of these issues more problematic. Hence, it is desirable and useful to provide an IC that has more flexibility to reduce one or more of these issues.

### SUMMARY

According to one or more examples, an electronic device includes a plurality of integrated circuits (ICs), each IC comprising an array of resources, and a regional clock circuitry comprising horizontal routing tracks located on each horizontal edge of each of the resources, and vertical routing tracks located on each vertical edge of each of the resources, and a global clock circuitry formed using the horizontal routing tracks and the vertical routing tracks, wherein at least one pair of the horizontal routing tracks located on horizontal IC interface circuitries or the vertical routing tracks located on vertical IC interface circuitries of at least two adjacent ICs of the plurality of ICs are tied together, the global clock circuitry configured to route a clock signal to each of the plurality of ICs.

According to one or more examples, an integrated circuit (IC) comprises an array of resources, and a first regional clock circuitry including a first clock route coupled to a global clock circuitry, the first clock route comprising clock route resources configured to route a clock signal received from the global clock circuitry to a first clock tree root of a first clock tree comprising clock tree resources, the first clock tree configured to route the clock signal from the first clock tree root to a first set of resources, and a switch box circuitry network comprising switch box circuitries located at intersections of the clock tree resources, the switch box circuitries configured to control the clock tree resources to change characteristics of the first clock tree.

In one or more examples, an electronic device includes a plurality of integrated circuits (ICs), each IC including an array of resources; and a regional clock circuitry including a first clock route coupled to a global clock circuitry, the first clock route comprising horizontal routing tracks and vertical routing tracks configured to route a clock signal received from the global clock circuitry to a first clock tree root of a first clock tree comprising clock tree resources, the first clock tree configured to route the clock signal from the first clock tree root to a first set of resources, and a switch box circuitry network comprising switch box circuitries located at intersections of the clock tree resources, the switch box circuitries configured to control the clock tree resources to change characteristics of the first clock tree, wherein the global clock circuitry is formed using the horizontal routing tracks and the vertical routing tracks, wherein at least one pair of the horizontal routing tracks located on the horizontal IC interface circuitries or the vertical routing tracks located on vertical IC interface circuitries of at least two adjacent ICs of the plurality of ICs are tied together, the global clock circuitry configured to route the clock signal to each of the plurality of ICs.

### BRIEF DESCRIPTION OF DRAWINGS

FIG. 1 is a simplified block diagram depicting an exemplary columnar Field Programmable Gate Array architecture, according to one or more examples.

FIG. 2 is a block diagram depicting an exemplary integrated circuit (IC), according to one or more examples.

FIG. 3 is a block diagram depicting an exemplary integrated circuit (IC) that includes a regional clock circuitry, according to one or more examples.

FIG. 4A illustrates a block diagram of an example clock tree of a regional clock circuitry, according to one or more examples.

FIG. 4B illustrates a block diagram of an example clock tree of a regional clock circuitry, according to one or more examples.

FIG. 4C illustrates a block diagram of an example clock tree of a regional clock circuitry, according to one or more examples.

FIG. 5 illustrates a block diagram of an example switch box circuitry, according to one or more examples.

FIG. 6 illustrates a block diagram of an example IC that includes regional clock circuitry that includes one or more clock trees, according to one or more examples.

FIG. 7 illustrates a block diagram of an example electronic device including multiple ICs 200, according to one or more examples.

FIG. 8A illustrates a block diagram of an example electronic device that includes a global clock circuitry in a first configuration.

FIG. 8B illustrates a block diagram of an example electronic device that includes a global clock circuitry in a second configuration.

### DETAILED DESCRIPTION

Integrated circuits (ICs) are a well-known type of device that can be programmed to perform specified logic functions. One type of IC, the field programmable gate array (FPGA), typically includes an array of programmable tiles. These programmable tiles can include, for example, input/output blocks (IOBs), configurable logic blocks (CLBs), dedicated random access memory blocks (BRAMs), multipliers, digital signal processing blocks (DSPs), processors, clock managers, delay lock loops (DLLs), and so forth.

Each programmable tile typically includes both programmable interconnect circuitry and programmable logic. The programmable interconnect circuitry typically includes a large number of interconnect lines of varying lengths interconnected by programmable interconnect points (PIPs). The programmable logic implements the logic of a user design using programmable elements that can include, for example, function generators, registers, arithmetic logic, and so forth.

The programmable interconnect circuitry and programmable logic are typically programmed by loading a stream of configuration data into internal configuration memory cells that define how the programmable elements are configured. The configuration data can be read from memory (e.g., from an external PROM) or written into the FPGA by an external device. The collective states of the individual memory cells then determine the function of the FPGA.

Another type of IC is the Complex Programmable Logic Device, or CPLD. A CPLD includes two or more “function blocks” connected together and to input/output (“I/O”) resources by an interconnect switch matrix. Each function block of the CPLD includes a two-level AND/OR structure similar to those used in Programmable Logic Arrays (“PLAs”) and Programmable Array Logic (“PAL”) devices. In CPLDs, configuration data is typically stored on-chip in non-volatile memory. In some CPLDs, configuration data is stored on-chip in non-volatile memory, then downloaded to volatile memory as part of an initial configuration (programming) sequence.

For all of these ICs, the functionality of the device is controlled by data bits provided to the device for that purpose. The data bits can be stored in volatile memory (e.g., static memory cells, as in FPGAs and some CPLDs), in non-volatile memory (e.g., FLASH memory, as in some CPLDs), or in any other type of memory cell.

Other ICs are programmed by applying a processing layer, such as a metal layer, that programmably interconnects the various elements on the device. These ICs are known as mask programmable devices. ICs can also be implemented in other ways, e.g., using fuse or antifuse technology. The terms “IC” and “programmable” include but are not limited to these exemplary devices, as well as encompassing devices that are only partially programmable. For example, one type of IC includes a combination of hard-coded transistor logic and a programmable switch fabric that programmably interconnects the hard-coded transistor logic.

Electronic devices that include ICs use regional and global clock circuitries. For example, an electronic device may include an array of FPGAs that each further include an array of resources formed therein. The electronic device may utilize a global clock circuitry to provide clock signal(s) to each of the FPGAs. The FPGAs may each include regional clock circuitries that provide said clock signal to one or more of the resources. However, as both the electronic devices, and the FPGAs themselves, have become increasingly larger timing uncertainties along with clock skew and clock delays have become more problematic. Conventionally, to resolve these issues balanced global and regional clock circuitries have been utilized. However, balanced clock circuitries are only balanced in one dimension and provide poor flexibility. For example, there are tradeoffs when constructing clock trees based on design constraints. For example, a low insertion clock tree may be better suited if the electronic device transfers data between two circuitries in which clock skew is less critical than insertion delay.

Embodiments herein are related to creation of a programmable (configurable) clock circuitries that can be configured based on design constraints.

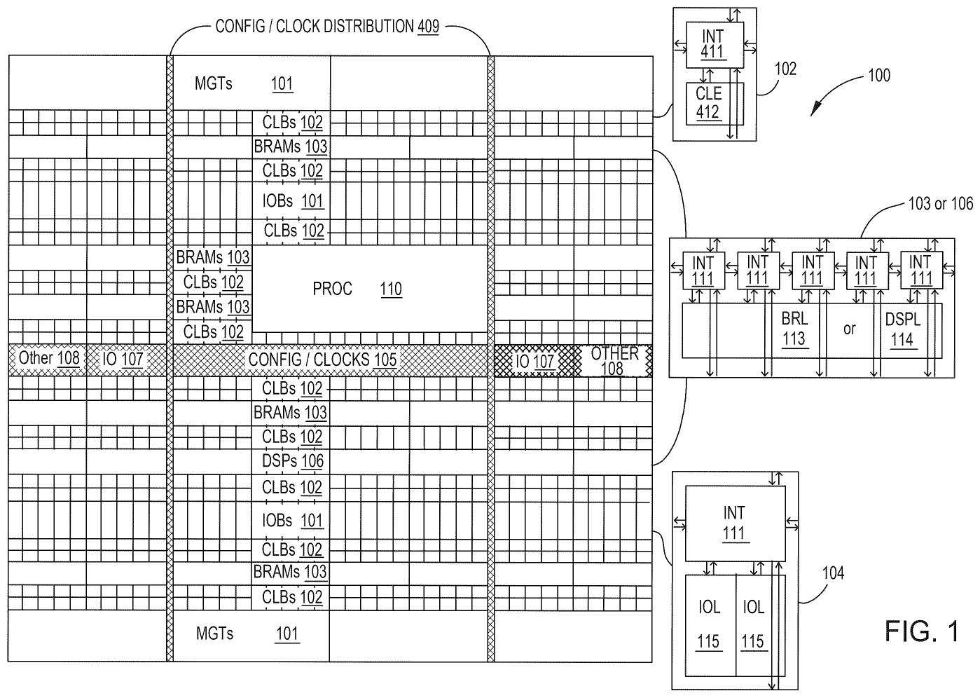

As noted above, advanced ICs, including FPGAs, can include several different types of programmable logic blocks in the array. FIG. 1 is a simplified block diagram depicting an exemplary columnar FPGA architecture, according to one or more examples. An electronic device 100 includes FPGA architecture that includes a large number of different programmable tiles including multi-gigabit transceivers (“MGTs”) 101, configurable logic blocks (“CLBs”) 102, random access memory blocks (“BRAMs”) 103, input/output blocks (“IOBs”) 104, configuration and clocking logic (“CONFIG/CLOCKS”) 105, digital signal processing blocks (“DSPs”) 106, specialized input/output blocks (“I/O”) 107 (e.g., configuration ports and clock ports), and other programmable logic 108 such as digital clock managers, analog-to-digital converters, system monitoring logic, and so forth. Some FPGAs also include dedicated processor blocks (“PROC”) 110.

In some FPGAs, each programmable tile includes a programmable interconnect element (“INT”) 111 having standardized connections to and from a corresponding interconnect element in each adjacent tile. Therefore, the programmable interconnect elements taken together implement the programmable interconnect structure for the illustrated FPGA. The programmable interconnect element 111 also includes the connections to and from the programmable logic element within the same tile, as shown by the examples included at the top of FIG. 1.

For example, a CLB 102 can include a configurable logic element (“CLE”) 112 that can be programmed to implement user logic plus a single programmable interconnect element (“INT”) 111. A BRAM 103 can include a BRAM logic element (“BRL”) 113 in addition to one or more programmable interconnect elements. Typically, the number of interconnect elements included in a tile depends on the height of the tile. In the pictured embodiment, a BRAM tile has the same height as five CLBs, but other numbers (e.g., four) can also be used. A DSP tile 106 can include a DSP logic element (“DSPL”) 114 in addition to an appropriate number of programmable interconnect elements. An IOB 104 can include, for example, two instances of an input/output logic element (“IOL”) 115 in addition to one instance of the programmable interconnect element 111. As will be clear to those of skill in the art, the actual I/O pads connected, for example, to the I/O logic element 115 typically are not confined to the area of the input/output logic element 115.

In the pictured embodiment, a horizontal area near the center of the die (shown in FIG. 1) is used for configuration, clock, and other control logic. Vertical columns 109 extending from this horizontal area or column are used to distribute the clocks and configuration signals across the breadth of the FPGA.

Some FPGAs utilizing the architecture illustrated in FIG. 1 include additional logic blocks that disrupt the regular columnar structure making up a large part of the FPGA. The additional logic blocks can be programmable blocks and/or dedicated logic. For example, processor block 110 spans several columns of CLBs and BRAMs.

Note that FIG. 1 is intended to illustrate only an exemplary FPGA architecture. For example, the numbers of logic blocks in a row, the relative width of the rows, the number and order of rows, the types of logic blocks included in the rows, the relative sizes of the logic blocks, and the interconnect/logic implementations included at the top of FIG. 1 are purely exemplary. For example, in an actual FPGA more than one adjacent row of CLBs is typically included wherever the CLBs appear, to facilitate the efficient implementation of user logic, but the number of adjacent CLB rows varies with the overall size of the FPGA.

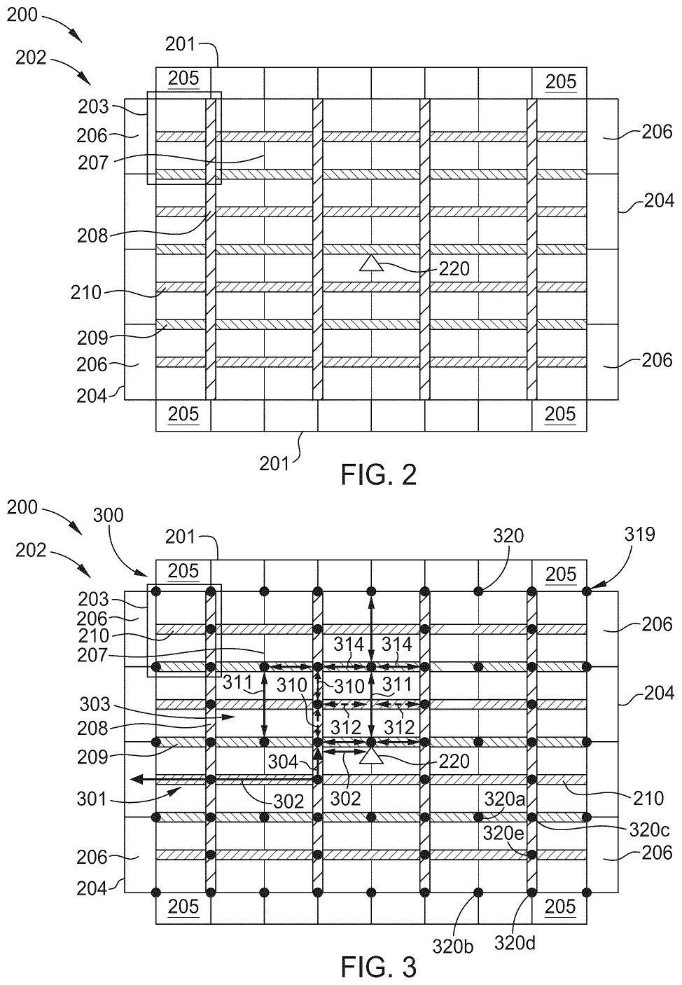

FIG. 2 is a block diagram depicting an exemplary integrated circuit (IC) 200, according to one or more examples. The IC 200 may be one or multiple ICs of an electronic device, such as an electronic device 100 (FIG. 1). In one example, the IC 200 may have an FPGA architecture or other architecture including an array of programmable logic resources.

In one or more examples, the IC 200 includes N-by-M array 202 (referred to herein as array 202) of resources 203. Resources 203 may be programmable (i.e., include programmable logic) and include, but are not limited to CLBs, programmable logic array blocks (LABS), or other form of fabric sub-regions (FSRs). Each resource 203 may be approximately the same height and width and may include a same set of circuit resources, namely resources 203 may be repeats of one another. Although an 8×4 array of resources 203 is shown, it is understood that any suitable quantity of resources 203 may be included in the array 202.

Array 202 of resources 203 may be bracketed top and bottom by arrays 201 of gigabit transceiver (“GT”) circuitries 205 and may be bracketed right and left by arrays 204 of IOB circuitries 206 (or vice versa). Stated otherwise, horizontal IC interface circuitries, located at the top and bottom edges of IC 200, may be bordered by array 201. Vertical IC interface circuitries, located on the left and right edges of IC 200, may be bordered by array 204. Arrays 201 and 204 may form parts of IC 200. Even though array 201 and array 204 are illustrated as 1×8 and 4×1 arrays, respectively, array 201 and array 204 may have any suitable dimensions.

In one or more examples, array 202 may include vertical on-chip (VNOC) channel circuitries 208 and horizontal on-chip channel (HNOC) circuitries 209. The VNOC channel circuitries 208 may be located on alternating vertical edges (i.e., a first vertical edge) of the resources 203. The vertical edges of resources 203 (i.e., second vertical edges) that are not included in a VNOC channel circuitry 208 are clock edge boundaries 207 (or vice versa). HNOC channel circuitries 209 are formed the on the horizontal edges of the resources 203. For example, a top edge and a bottom edge of each of the resources 203, with the exception of the horizontal edges that are bordered by a GT circuitry 205, are located within a HNOC channel circuitry 209. In one or more examples, the VNOC channel circuitries 208 and the HNOC channel circuitries 209 are configured to transmit time packets of data from one location to another location of the IC 200 (or other ICs formed in an electronic device).

Array 202 may also include RCLK channel circuitries 210 formed across horizontally across the array 202. The RCLK channel circuitries 210 may be formed across a portion of the resources 203, such as the center of the resources 203.

In one or more examples, IC 200 may be coupled to a clock source provided by an external clock circuitry that is provided (i.e., routed) to each resource 203 using a regional clock circuitry.

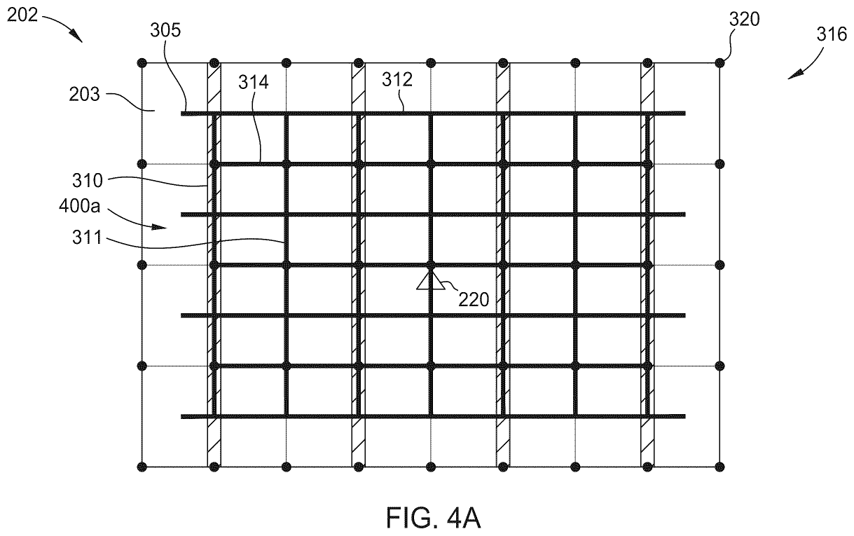

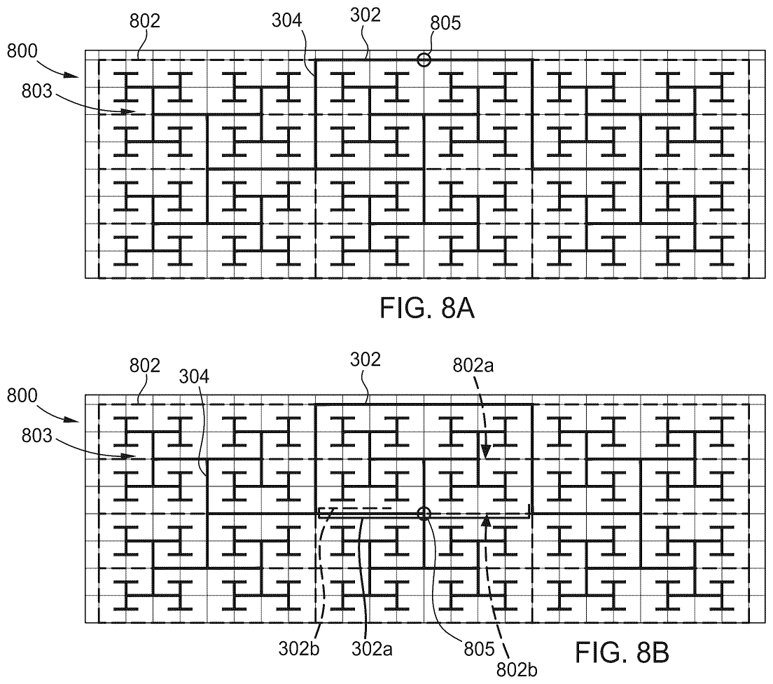

FIG. 3 is a block diagram depicting an exemplary integrated circuit (IC) 200 that includes a regional clock circuitry 300, according to one or more examples. Regional clock circuitry 300 may include different types of clock tracks used to route a clock signal to clock leaves within resources 203 used to receive the clock signal. In one or more examples, regional clock circuitry 300 includes clock route 301 coupled to clock tree 303. In one or more examples, clock route 301 coupled to (or is also part of) a global clock circuitry, such as global clock circuitry 803 (FIGS. 8A-8B) that routes a clock signal to clock tree root 220 (i.e., a root of the clock tree). Clock tree 303 is used to distribute (i.e., branches out) the clock signal received from the global clock circuitry to each of the resources 203 from clock tree root 220.

In one or more examples, clock route 301 may be composed of one or more clock tracks including horizontal routing tracks 302 and/or one or more vertical routing tracks 304. The horizontal routing tracks 302 and the vertical routing tracks 304 may also be described herein collectively as “clock route resources.” In an example, horizontal routing tracks 302 and vertical routing tracks 304 are segmented at boundaries of resources 203, and are bidirectional. Horizontal routing tracks 302 are located on both horizontal (i.e., top and bottom) edges of each resource 203. Vertical routing tracks 304 are located on alternating vertical edges of each resource 203. The vertical routing tracks 304 are included on edges of resources that include VNOC channel circuitries 208. In this example, the clock route 301 extends across 4 resources 203 in the horizontal direction and 1 resource 203 in the vertical direction. Thus, the clock route 301 utilizes 4 horizontal routing tracks 302 and 1 vertical routing track 304. As noted above, multiple clock routes may be used to route different clock sources to multiple clock tree roots included in the array 202. In other examples, different numbers of routing track segments may be used to provide a route to clock tree root 220.

In one or more examples, the clock signal is provided to the resources 203 via clock tree 303. Clock tree 303 branches out from clock tree root 220. In one or more examples, clock tree 303 includes (and regional clock circuitry 300 further includes) one or more distribution tracks and one or more spines. Spines are clock tree resources that are coupled to (i.e., branch out from) clock tree root 220 and distribution tracks branch out from the spines to provide the clock signal to resources 203. For example, regional clock circuitry 300 is segmented and may include vertical spines 311, horizontal spines 314, vertical distribution tracks 310, and horizontal distribution tracks 312 (also defined herein collectively as referred to as “clock tree resources”). Vertical routing tracks 304 and vertical spines 311 are one segment tall. Vertical distribution tracks 310 are each half a segment tall. Each of the clock tree resources and clock route resources that extend horizontally (horizontal routing tracks 302, horizontal distribution tracks 312 and horizontal spines 314) are one segment wide. Any combination of routing tracks, distribution tracks, and spines may be used to route the clock signal to one or more of the resources 203.

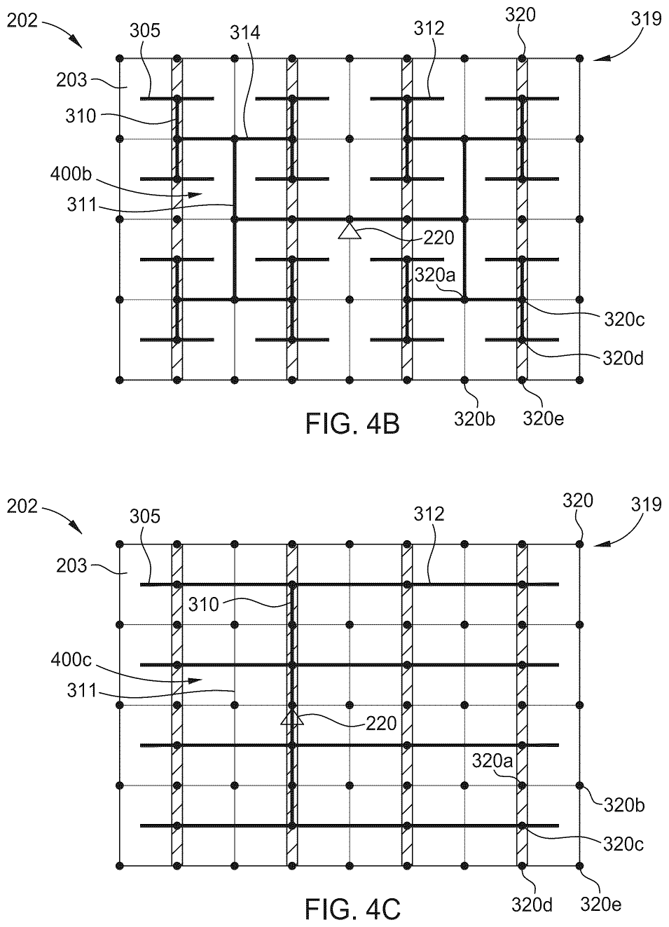

In one or more examples, horizontal spines 314 and horizontal routing tracks 302 are located on the top and bottom edges of each of the resources 203 and extend across each of the resources. Vertical spines 311 are located on each clock edge boundary 207 of each of the resources 203. Stated differently, vertical spines 311 are located on vertical edges of the resources 203 that do not include VNOC channel circuitries 208. Vertical distribution tracks 310 are located on each vertical edge of the resources 203 that include VNOC channel circuitries 208. Stated otherwise, the vertical edges of the resources 203 alternate between including vertical distribution tracks 310 and vertical spines 311. On the other hand, each of the vertical edges include a vertical routing track 304. Horizontal distribution tracks 312 are located at a position between the top and bottom edges of the resources 203 (i.e., the center) and extend horizontally across the resources 203 within the RCLK channel circuitries 210. In one or more examples, horizontal distribution tracks 312 provide the clock signal to clock leaves 305 (FIGS. 4A-4C) located in each of the resources 203. Stated otherwise, horizontal distribution tracks 312 intersect with clock leaves 305. Each of the clock route and clock tree resources are formed on each edge of each resource 203 in the manner described above including on the edges of resources 203 that are adjacent to the array 201 and the array 204 (defined herein horizontal IC interface circuitries and vertical IC interface circuitries, respectively). The clock tree and clock route resources formed on the IC interface circuitries are able to extend to other ICs of an electronic device, allowing for a global clock circuitry between ICs to be formed. This will be described in more detail below.

Regional clock circuitry 300 includes switch box circuitry network 319. In one or more examples, switch box circuitry network 319 includes switch box circuitries 320. The switch box circuitries 320 are used to configure (or change) the route that the clock signal follows to the resources 203 (i.e., construct the clock tree 303) based on desired based on overall design constraints. Stated otherwise, the switch box circuitry network 319 is operable to change characteristics of the clock tree 303 (or multiple clock trees if included) by enabling/disabling different clock tree resources. Characteristics of the clock tree 303 include, but are not limited to, the clock skew (i.e., the difference in time in which resources 203 receive the clock signal), the insertion delay (i.e., total time it takes the clock signal to reach resources 203), the average delay (i.e., the average time it takes for the clock signal to reach the resources), clock power, or the like. For example, the switch box circuitries 320 are located at intersections of clock tree resources and are operable to configure enable/disable the clock tree resources to generate a balanced (low clock skew) clock tree, a low insertion delay clock tree, or the like. In one example, a balanced clock tree is a clock tree that uses an equal amount of segments (clock tree resources) to route a clock signal from clock tree root 220 to each corresponding resource 203. Because a balanced clock tree uses an equal amount of segments, the arrival time of the clock signal to each resource 203 is as close to the same as possible, and minimizes the clock skew (the difference in time each resource 203 receives the clock signal). In another example, a low insertion delay clock tree is a clock tree that uses the lowest possible quantity of clock tree resources to reach each corresponding resource 203. By using the lowest possible quantity of segments, a low insertion delay clock tree ensures that each corresponding resource 203 receives the clock signal from clock tree root 220 as quickly as possible, reducing the insertion delay. In one or more examples, the switch box circuitries 320 include a collection of multiplexers that are controlled using configuration memory cells. The memory cells are programmed (configured) to statically select a clock signal. The switch box circuitries 320 can change state during any configuration or reconfiguration event. In other examples, the switch box circuitries 320 are also configured to enable/disable clock routing resources to configure a global clock circuitry.

First switch box circuitries 320a and second switch box circuitries 320b are located at intersections of vertical spines 311 and horizontal spines 314. Stated otherwise, first switch box circuitries 320a and second switch box circuitries 320b are located between segments of vertical spines 311, horizontal spines 314, and horizontal routing tracks 302. First switch box circuitries 320a and second switch box circuitries 320b are located on a same first vertical plane (i.e., are vertically separated from each other). Third switch box circuitries 320c and fourth switch box circuitries 320d are located at intersections of horizontal spines 314 and vertical distribution tracks 310. Stated otherwise, third switch box circuitries 320c and fourth switch box circuitries 320d are located between segments of horizontal spines 314, vertical distribution tracks, horizontal routing tracks 302, and vertical routing tracks 304. Third switch box circuitries 320c and fourth switch box circuitries 320d are located on a same second vertical plane. Fifth switch box circuitries 320e are located on the second vertical plane and between third switch box circuitries 320c and fourth switch box circuitries 320d. Fifth switch box circuitries 320e are located at intersections of vertical distribution tracks 310 and horizontal distribution tracks 312. Stated otherwise, the fifth switch box circuitries 320e are only located in VNOC channel circuitries 208. First switch box circuitries 320a and third switch box circuitries 320c are located in a same first horizontal plane (i.e., are horizontally separated). Second switch box circuitries 320b and fourth switch box circuitries 320d are located in a same second horizontal plane.

In one or more examples, switch box circuitries 320 are used to enable/disable different clock tree resources of clock tree 303. Stated differently, switch box circuitries 320 are used to enable/disable (e.g., control or configure) different clock tree resources to route the clock signal to some or all of the resources 230 based on desired characteristics of the clock tree 303. Advantageously, switch box circuitry network 319 allows clock tree 303 to be configurable to be based on design constraints.

FIG. 4A illustrates a block diagram of an example clock tree 400a of a regional clock circuitry 300, according to one or more examples. For illustrative purposes only, the RCLK channel circuitries 210, and the HNOC channel circuitries 209 are not shown in FIG. 4A The example clock tree 400a corresponds to the clock tree 303 in a first configuration. In the first configuration, all of the clock tree resources are enabled by switch box circuitries 320, forming a mesh. The clock signal is provided to each of the resources. It should be noted for illustration purposes only the array 202 and the clock tree 303 of IC 200 is shown in FIG. 4A. In the first configuration, the closer a resource 203 is to clock tree root 220, the shorter the distance the clock signal must travel from clock tree root 220. For example, the closer a resource 203 is to clock tree root 220 (the center of the array 202), the shorter the distance the clock signal must travel. Therefore, the clock signal will reach resources 203 closer to the center of the array 202 earlier than resources 203 located on the corners of the array 202. The difference in distances the clock signal must travel to different resources 203 creates a difference in arrival time between different resources 203 (i.e., clock skew) and degrades the performance of the IC 200 (FIG. 2).

To reduce clock skew, conventional ICs position the clock tree resources in a manner such that the clock signal travels and equal amount of segments to each resource 203 (i.e., a balanced clock tree). However, a balanced clock tree is not always ideal for each clock tree design. Each type of clock tree includes a tradeoff between characteristics based on design constraints such as clock skew, jitter, intra versus inter clock timing, and the like. For example, a low insertion type clock tree may be more beneficial if there are critical timing paths in the clock circuitry, there is extra timing slack for loads closer to the clock source, or in any other case where total delay is prioritized over skew. Advantageously, switch box circuitry network 319 is able to enable/disable different combinations of the clock tree and clock routing resources to change the characteristics of the clock tree 303 (form different types of clock trees) such as a balanced clock tree, a low insertion clock tree, or the like based on design constraints. Additionally, switch box circuitry network 319 allows configuration of regional clock circuitry 300 on a per track basis, allows for the formation of clock trees of different sizes and/or aspect ratios in a clock circuitry, and allows for the formation of multiple clock trees of the same or different types in a same IC 200. Stated differently, switch box circuitries 320 can enable/disable different segments of clock tree resources to form a clock tree that best fits a desired design.

FIG. 4B illustrates a block diagram of an example clock tree 400b of a regional clock circuitry 300, according to one or more examples. For illustrative purposes only, the RCLK channel circuitries 210, and the HNOC channel circuitries 209 are not shown in FIG. 4B. The example clock tree 400b corresponds to the clock tree 303 in a second configuration. It should be noted for illustration purposes only the array 202 and the clock tree 303 of IC 200 is shown in FIG. 4B. In one or more examples, the second configuration is a balanced clock tree. As noted above, switch box circuitries 320 are used to enable/disable vertical spines 311, horizontal spines 314, vertical distribution tracks 310, and horizontal distribution tracks 312 to form a balanced clock tree. A balanced clock tree is a clock tree configuration in which the clock signal travels an equal amount of segments to each resource 203. For example, as illustrated in FIG. 4B, the clock signal travels 5 segments to each resource.

FIG. 4C illustrates a block diagram of an example clock tree 400c of a regional clock circuitry 300, according to one or more examples. For illustrative purposes only, the RCLK channel circuitries 210, and the HNOC channel circuitries 209 are not shown in FIG. 4C. The example clock tree 400c corresponds to the clock tree 303 in a third configuration. It should be noted for illustration purposes only the array 202 and the clock tree 303 of IC 200 is shown in FIG. 4C. In one or more examples, the second configuration is a low insertion delay clock tree. As noted above, in the second configuration, each resource 203 receives the clock signal from clock tree root 220 using the shortest possible path. As noted above switch box circuitries 320 are used to enable/disable vertical spines 311, horizontal spines 314, vertical distribution tracks 310, and horizontal distribution tracks 312 to form the low insertion delay clock tree. For example, the switch box circuitries 320 are used to activate each of the vertical spines 311 located in a same vertical plane as the clock tree root 220 and each of the horizontal distribution tracks 312 while leaving the remainder of the clock tree resources disabled.

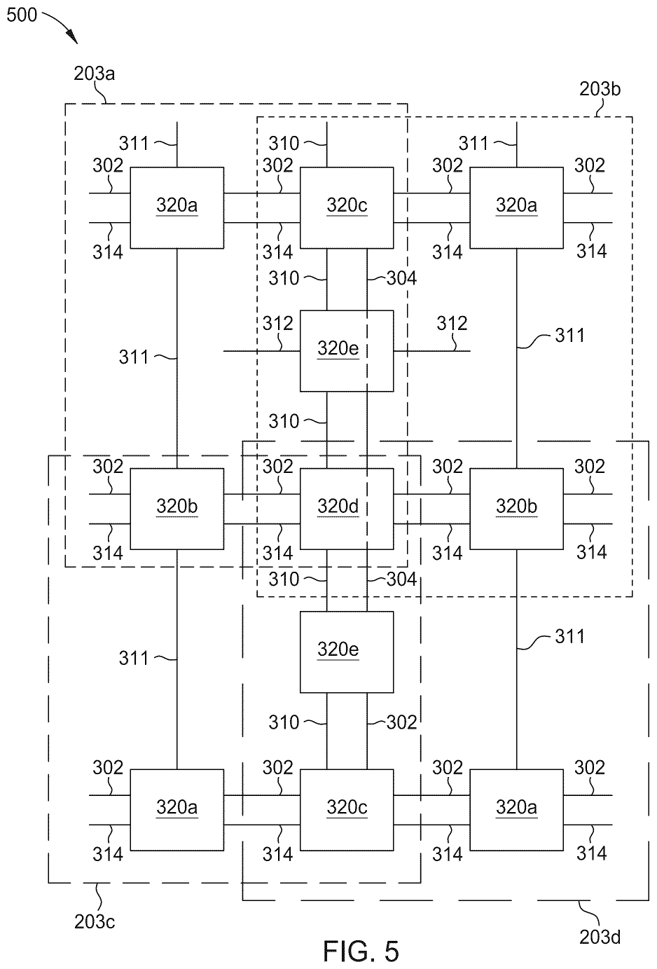

FIG. 5 illustrates a block diagram of an example switch box circuitry network 500, according to one or more examples. Example switch box circuitry network 500 may be a portion of switch box circuitry network 319. As noted above switch box circuitry network 500 includes first switch box circuitries 320a and second switch box circuitries 320b located at intersections between vertical spines 311 and horizontal spines 314 and between segments of horizontal routing tracks 302, third switch box circuitries 320c and fourth switch box circuitries 320d located at intersections between horizontal spines 314 vertical distribution tracks 310 and between segments of horizontal routing tracks 302 and vertical routing tracks 304, and fifth switch box circuitries 320e located between third switch box circuitries 320c and fourth switch box circuitries 320d. First switch box circuitries 320a, second switch box circuitries 320b, third switch box circuitries 320c, and fourth switch box circuitries 320d are located on the corners of each of the resources 203. Fifth switch box circuitries 320e are located between the third switch box circuitries 320c and the fourth switch box circuitries 320d. Common first switch box circuitries 320a, second switch box circuitries 320b, third switch box circuitries 320c, fourth switch box circuitries 320d, and fifth switch box circuitries 320e may be shared between adjacent resources. For example, a first resource 203a includes first switch box circuitry 320a located on a top-left corner, second switch box circuitry 320b located on a bottom-left corner, third switch box circuitry 320c located on a top-right corner, a fourth switch box circuitry 320d located on a bottom-right corner, and a fifth switch box circuitry 320e located between the top-right and bottom-right corners. A second resource 203b located in a same row of the array 202 and to the right of the first resource 203a may share third switch box circuitries 320c, fourth switch box circuitries 320d, and fifth switch box circuitries 320e. For example, the second resource 203b may include the shared third switch box circuitry 320c located on a top-left corner, the shared fourth switch box circuitry 320d located on a bottom-left corner, and the shared fifth switch box circuitry 320e located between the top-left and bottom-left corners. The second resource 203b further includes first switch box circuitry 320a located on a top-right corner and second switch box circuitry 320b located on a bottom-right corner. In a similar manner, a resource (not shown) located in the same row and to the left of the first resource 203a would share first switch box circuitry 320a and second switch box circuitry 320b.

In another example, a third resource 203c is located in a same column and directly below the first resource 203a. The third resource 203c shares second switch box circuitry 320b with the first resource 203a. The third resource 203c also shares fourth switch box circuitry 320d with the first resource 203a and the second resource 203b. The third resource 203c includes second switch box circuitry 320b in a top-right corner, first switch box circuitry 320a in a bottom-left corner, fourth switch box circuitry 320d in a top-left corner, third switch box circuitry 320c in a bottom-right corner, and fifth switch box circuitry 320e located between the top-right and bottom-right corners. In a similar manner, a resource (not shown) located in the same column and directly above of the first resource 203a would share first switch box circuitry 320a and third switch box circuitry 320c.

A fourth resource 203d is located directly to the right of the third resource 203c and directly below the second resource 203b. The fourth resource 203d shares third switch box circuitry 320c and fifth switch box circuitry 320e with the third resource 203c. The fourth resource 203d also shares fourth switch box circuitry 320d with each of the first resource 203a, the second resource 203b, and the third resource 203c. The fourth resource 203d includes fourth switch box circuitry 320d in a top-left corner, third switch box circuitry 320c in a bottom-left corner, second switch box circuitry 320b in a top-right corner, first switch box circuitry 320a in a bottom-right corner, and fifth switch box circuitry 320e between the top-left and bottom-left corners. Although a 2×2 array of resources is descried, any sized array of resource and corresponding switch box circuitry network may be used.

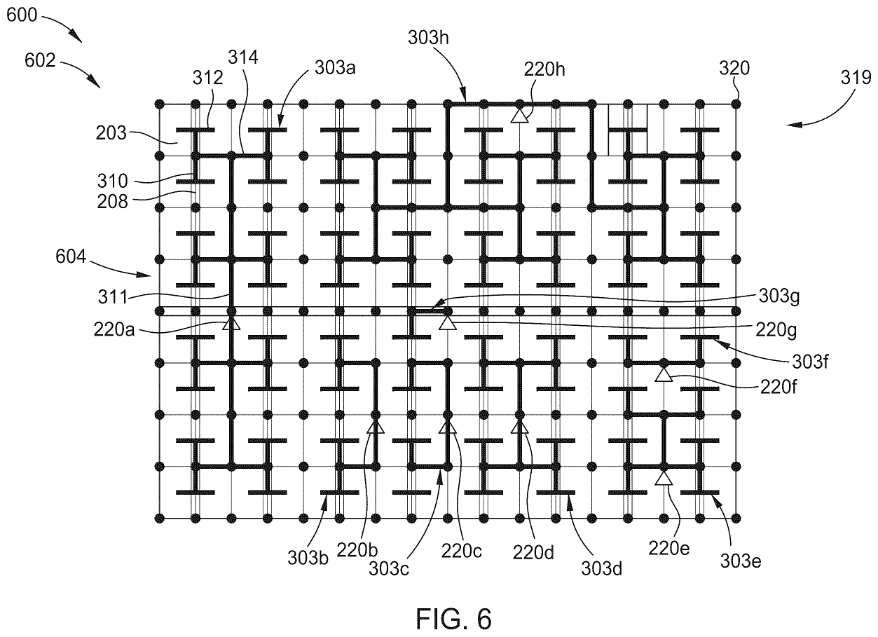

FIG. 6 illustrates a block diagram on an example IC 600 that includes regional clock circuitry 604 that includes one or more clock trees, according to one or more examples. The IC 600 includes an array 602 of resources 203. The IC 600 may correspond to and include the same clock tree resources (and clock routing resources) as IC 200. The IC 600 also includes switch box circuitry network 319. The IC 600 includes regional clock circuitry 604 that includes a plurality of clock trees. For example, regional clock circuitry 604 includes different clock tree roots that branch out into different of clock trees. The clock tree roots may each be coupled to a same global clock circuitry or different global clock circuitries. In the same manner described above, the different clock trees are routed by switch box circuitry network 319 by enabling/disabling different clock tree and clock routing resources. For example, regional clock circuitry 604 includes a first clock tree 303a that distributes a clock signal received at a first clock tree root 220a to a first set of resources 203. Regional clock circuitry 604 includes a second clock tree 303b that distributes a clock signal received at a second clock tree root 220b to a second set of resources 203. Regional clock circuitry 604 includes a third clock tree 303c that distributes a clock signal received at a third clock tree root 220c to a third set of resources 203. Regional clock circuitry 604 includes a fourth clock tree 303d that distributes a clock signal received at a fourth clock tree root 220d to a fourth set of resources 203. Regional clock circuitry 604 includes a fifth clock tree 303e that distributes a clock signal received at a fifth clock tree root 220e to a fifth set of resources 203. Regional clock circuitry 604 includes a sixth clock tree 303f that distributes a clock signal received at a sixth clock tree root 220f to a sixth set of resources 203. Regional clock circuitry 604 includes a seventh clock tree 303g that distributes a seventh clock signal received at a seventh clock tree root 220g to a seventh set of resources 203. Regional clock circuitry 604 includes an eighth clock tree 303h that distributes a clock signal received at an eighth clock tree root 220h to an eighth set of resources 203. Advantageously, the switch box circuitry network 319 allows different clock trees of the same or different sizes and aspect ratios to be formed in a single-track layer.

It should also be noted that even though each of the clock trees are the same type of clock trees (balanced clock trees), this is for example purposes only, and the IC 600 may advantageously include different types of clock trees.

In one or more examples, an electronic device may include multiple ICs (an array of IC dies), such as IC 200, that are coupled together. In one or more examples, a global clock circuitry formed using the clock route resources can be used to route a same clock signal to each IC 200. The characteristics (the clock circuitry type) of the global clock circuitry are configurable using the switch box circuitry network 319 based on design constraints. In one example, the switch box circuitry network 319 of each IC 200, in the same manner described above, is used to form a balanced global clock circuitry (or any other type of clock circuitry). For example, the balanced global clock circuitry allows the clock signal to travel an equal distance from the clock source to clock tree root 220 of each IC 200. Advantageously, the balanced clock tree between each IC reduces clock skew.

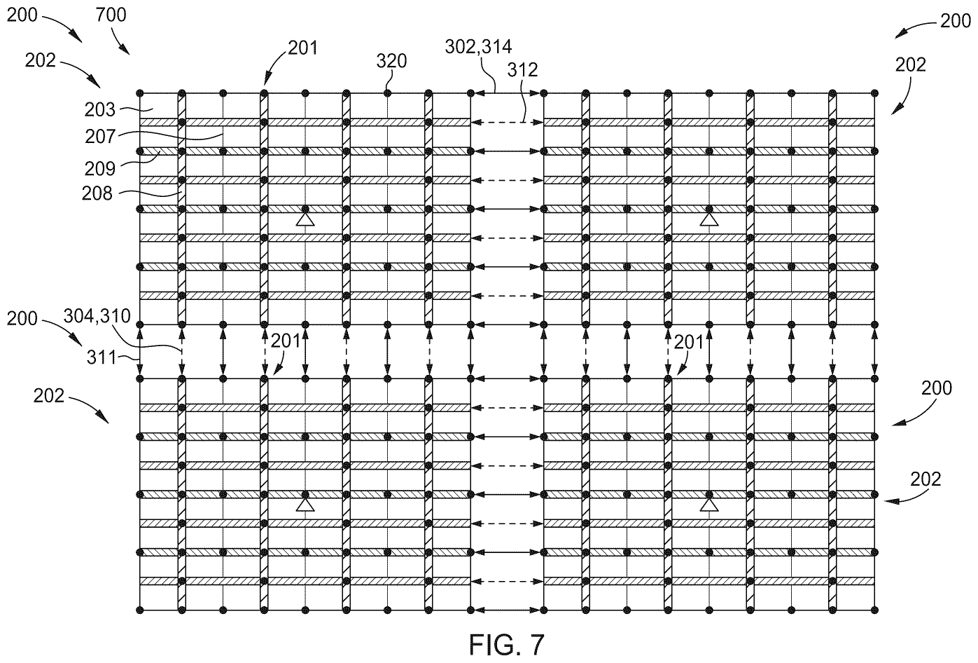

FIG. 7 illustrates a block diagram of an example electronic device including multiple ICs 200, according to one or more examples. As shown in FIG. 7, and as described above, the clock tree resources and clock routing resources formed on the vertical IC interface circuitries and horizontal IC interface circuitries may extend to an adjacent IC 200. For example, vertical spines 311 may extend between clock edge boundaries 207 (i.e., horizontal IC interface circuitries) between adjacent ICs 200 that are vertically displaced from one another. Vertical routing tracks 304 and vertical distribution tracks 310 may extend between VNOC channel circuitries 208 (i.e., horizontal IC interface circuitries) of vertically adjacent ICs 200. In a similar manner, horizontal distribution tracks 312 may extend between RCLK channel circuitries 210 (i.e., vertical IC interface circuitries) of horizontally adjacent ICs 200. Horizontal spines 314 and horizontal routing tracks 302 may extend between HNOC channel circuitries 209 (i.e., vertical IC interface circuitries) of horizontally adjacent ICs 200.

FIG. 8A illustrates a block diagram of an example electronic device 800 that includes a global clock circuitry 803 in a first configuration. In one or more examples, the electronic device 800 includes multiple ICs 802 that interface in the same manner described in FIG. 7. ICs 802 correspond to IC 200 (FIGS. 2-5). Electronic device 800 includes a 3×4 array of ICs 802. Electronic device 800 includes 12 ICs 802 in total. Even though a 3×4 array of ICs 802 is described, this is for example purposes only, and any quantity of rows and columns of ICs 802 may be used.

In one or more examples, electronic device 800 includes a global clock circuitry 803. Global clock circuitry 803 is used to provide a clock signal from a clock source to a global clock root 805 to one or more regional clock tree roots of each of the ICs 802 (such as clock tree root 220 for example). Stated otherwise, global clock circuitry 803 provides a clock signal to each regional clock circuitry 300 of each IC 802. Global clock circuitry 803 provides a clock signal to the one or more regional clock tree roots within ICs 802 using the horizontal routing tracks 302 and vertical routing tracks 304 located on the horizontal and vertical interface circuitries of ICs 802. Regional clock circuitry (such as regional clock circuitry 300) of each of the ICs 802 are then used to route the clock signal to each of the resources 203. For example, the global clock circuitry 803 utilizes one or more horizontal routing tracks 302 and/or one or more vertical routing tracks 304 of the ICs 802 to route the clock signal to the one or more regional clock trees roots.

Although ICs 802 are described as receiving a same clock signal from a single global clock root 805, in some examples, only some of the ICs 802 may receive the clock signal from the clock source (i.e., global clock root 805). In other examples, multiple clock signals from multiple clock sources may be provided to different combinations of ICs 802 using multiple global clock circuitries.

Although global clock circuitry 803 is a balanced clock circuitry, in the same manner described above, characteristics of global clock circuitry 803 are configurable (controllable) based on design constraints using switch box circuitry network 319. Any suitable balanced global clock circuitry or a global clock circuitry of any type (i.e., a low insertion clock circuitry) may be used.

In one example, global clock root 805 may be located at the horizontal center of the electronic device 800 and above the ICs 802. For example, the global clock root 805 can be located at the center of the top edge of the IC 802 located in the first row and the second column of the array of ICs 802. Global clock root 805 may be located anywhere in the electronic device 800. As illustrated in FIG. 8A, global clock circuitry 803 is balanced as it takes 19 clock segments to reach each at least one regional clock route of the ICs 802. However, the more clock segments (the longer the distance of each route) to one or more regional clock tree roots the longer it takes the clock signal to reach of the ICs 802. The more clock segments required, the higher the insertion delay of the electronic device 800.

However, because the ICs 802 each have their own set of clock route resources, at the IC interface circuitries (boundaries) of the ICs 802 there are duplicates (i.e., double the clock routing resources). Advantageously, clock routing resources located between at least one of the horizontal or vertical IC interface circuitries of two adjacent ICs 802 can be folded (tied) together to update to reduce the distance between one or regional clock tree roots of each of the ICs 802 and the global clock root 805.

FIG. 8B illustrates a block diagram of an example electronic device that includes a clock circuitry in a second configuration. As noted above because, the IC interface circuitries of each the ICs 802 include their own set of clock route resources, double the clock route resources are present. In one example, to reduce the number of segments between global clock root 805 and one or more regional clock tree roots, at least one pair of clock route resources located between a first IC 802a and a second IC 802b can be tied together. Stated otherwise, the at least one pair of clock route resources located between the first IC 802a and the second IC 802b can be connected (i.e., tied together), forming a single clock route resource. First IC 802a may be located in the second row and second column of the array of ICs 802. Second IC 802b may be located in the third row and second column of the array of ICs 802. Because horizontal routing tracks 302 are located on, the bottom horizontal IC interface circuitry of first IC 802a and the top horizontal IC interface circuitry of second IC 802b, horizontal routing tracks 302 on the adjacent horizontal IC interface circuitries are tied together. Therefore, first horizontal routing tracks 302a located on the bottom horizontal edge of first IC 802a are tied to a second horizontal routing tracks 302b located on the top horizontal edge of second IC 802b, forming the second configuration. Stated otherwise, horizontal routing tracks 302 located adjacent horizontal interface circuitries and/or vertical routing tracks 304 located on adjacent vertical interface circuitries may be tied together. As illustrated in FIG. 8B, in the second configuration, the global clock root 805 is also re-located to the center of the bottom edge of first IC 802a and second IC 802b. Advantageously, because the first horizontal routing track 304a and the second horizontal routing track 304b are tied together, the distance from global clock root 805 to any of the one or more regional clock tree roots is reduced to 15 segments, reducing the quantity of segments by 30%. Thus reducing the insertion delay. Although one pair of horizontal routing tracks 302 is tied together, this is for example purposes only. Any quantity of pairs of horizontal routing tracks 302 and/or vertical routing tracks 304 may be tied together to reduce the quantity of clock segments.

Advantageously, the switch box circuitry network 319 used in conjunction with the clock tree resources and clock route resources allow for configurable global and/or regional clock circuitries. For example, the switch box circuitry network 319 allows for the characteristics and/or type of regional clock trees and/or global clock network circuitries based on design constraints. Furthermore, multiple configurable regional clock trees of the same or different characteristics may be formed on a single IC. Additionally, the insertion delay of global clock network circuitries can be reduced by tying clock routing resources on IC interfaces of adjacent ICs of an electronic device to reduce the distance traveled from the clock source to one or regional clock tree roots (such as clock tree root 220).

While the foregoing is directed to specific examples, other and further examples may be devised without departing from the basic scope thereof, and the scope thereof is determined by the claims that follow.

What is claimed is:

1. An electronic device comprising:
a plurality of integrated circuits (ICs), each IC comprising:
an array of resources; and
a regional clock circuitry comprising horizontal routing tracks located on each horizontal edge of each of the resources, and vertical routing tracks located on each vertical edge of each of the resources; and
a global clock circuitry formed using the horizontal routing tracks and the vertical routing tracks, wherein at least one pair of the horizontal routing tracks located on horizontal IC interface circuitries or the vertical routing tracks located on vertical IC interface circuitries of at least two adjacent ICs of the plurality of ICs are tied together, the global clock circuitry configured to route a clock signal to each of the plurality of ICs.

2. The electronic device of claim 1, wherein the regional clock circuitry further comprises:
a clock tree configured to receive the clock signal at a clock tree root, the clock tree comprising clock tree resources coupled to the clock tree root and configured to route the clock signal from the clock tree root to one or more of the resources; and
a switch box circuitry network comprising switch box circuitries located at intersections of the clock tree resources, the switch box circuitries configured to control the clock tree resources to change characteristics of the clock tree.

3. The electronic device of claim 2, wherein the clock tree resources comprise vertical spines, horizontal spines, vertical distribution tracks, and horizontal distribution tracks.

4. The electronic device of claim 3, wherein: vertical circuitry on-chip (VNOC) channel circuitries are located on first vertical edges of each of the resources; clock edge boundaries are located on second vertical edges of each of the resources; the vertical spines are located on each clock edge boundary; and the vertical distribution tracks are located on each VNOC channel circuitry.

5. The electronic device of claim 3, wherein the horizontal spines are located on top edges and bottom edges of each of the resources.

6. The electronic device of claim 3, wherein the switch box circuitry network comprises:
first switch box circuitries and second switch box circuitries located at intersections between the vertical spines and the horizontal spines, wherein the first switch box circuitries and the second switch box circuitries are formed on a first vertical plane;
third switch box circuitries and fourth switch box circuitries located at intersections between the horizontal spines and the vertical distribution tracks, wherein the third switch box circuitries and the fourth switch box circuitries formed on a second vertical plane; and
fifth switch box circuitries located at intersections between the vertical distribution tracks and the horizontal distribution tracks, wherein: the fifth switch box circuitries are located on the second vertical plane between the third switch box circuitries and the fourth switch box circuitries; the first switch box circuitries and the third switch box circuitries are formed on a first horizontal plane; and the second switch box circuitries and the fourth switch box circuitries are formed on a second horizontal plane.

7. The electronic device of claim 2, wherein characteristics of the clock tree include clock skew, insertion delay, average delay, and clock power.

8. The electronic device of claim 2, wherein the clock tree is a balanced clock tree, or a low insertion delay clock tree.

9. The electronic device of claim 1, wherein the global clock circuitry is a balanced clock tree.

10. An integrated circuit (IC) comprising:
a first regional clock circuitry comprising:
a first clock route coupled to a global clock circuitry, the first clock route comprising clock route resources configured to route a clock signal received from the global clock circuitry to a first clock tree root of a first clock tree comprising clock tree resources, the first clock tree configured to route the clock signal from the first clock tree root to a first set of resources; and
a switch box circuitry network comprising switch box circuitries located at intersections of the clock tree resources, the switch box circuitries configured to control the clock tree resources to change characteristics of the first clock tree.

11. The IC of claim 10, wherein the clock route resources comprise horizontal routing tracks located on horizontal edges of the first set of resources and vertical routing tracks located on vertical edges of the first set of resources.

12. The IC of claim 10, wherein the first clock route is configured to route the clock signal from a global clock circuitry to the first clock tree root of the first clock tree.

13. The IC of claim 10, wherein the clock tree resources comprise vertical spines, horizontal spines, vertical distribution tracks, and horizontal distribution tracks.

14. The IC of claim 13, wherein: vertical circuitry on-chip (VNOC) channel circuitries are located on first vertical edges of each of the first set of resources; clock edge boundaries are located on second vertical edges of each of the first set of resources; the vertical spines are located on each clock edge boundary; and the vertical distribution tracks are located in each VNOC channel circuitry.

15. The IC of claim 13, wherein the horizontal spines are located on top edges and bottom edges of each of the first set of resources.

16. The IC of claim 13, wherein the horizontal distribution tracks are located between a top edge and a bottom edge of each of the first set of resources.

17. The IC of claim 13, wherein the switch box circuitry network comprises:
first switch box circuitries and second switch box circuitries located at intersections between the vertical spines and the horizontal spines, wherein the first switch box circuitries and the second switch box circuitries are formed on a first vertical plane;
third switch box circuitries and fourth switch box circuitries located at intersections between the horizontal spines and the vertical distribution tracks, wherein the third switch box circuitries and the fourth switch box circuitries formed on a second vertical plane; and
fifth switch box circuitries located at intersections between the vertical distribution tracks and the horizontal distribution tracks, wherein: the fifth switch box circuitries are located on the second vertical plane between the third switch box circuitries and the fourth switch box circuitries; the first switch box circuitries and the third switch box circuitries are formed on a first horizontal plane; and the second switch box circuitries and the fourth switch box circuitries are formed on a second horizontal plane.

18. The IC of claim 10, wherein characteristics of the first clock tree include clock skew, insertion delay, average delay, and clock power.

19. The IC of claim 10, wherein the IC further comprises a second regional clock circuitry coupled to the global clock circuitry, the second regional clock circuitry configured to route the clock signal to a second set of resources.

20. An electronic device comprising:
a plurality of integrated circuits (ICs), each IC comprising:
a regional clock circuitry comprising:
a first clock route coupled to a global clock circuitry, the first clock route comprising horizontal routing tracks and vertical routing tracks configured to route a clock signal received from the global clock circuitry to a first clock tree root of a first clock tree comprising clock tree resources, the first clock tree configured to route the clock signal from the first clock tree root to a first set of resources; and
a switch box circuitry network comprising switch box circuitries located at intersections of the clock tree resources, the switch box circuitries configured to control the clock tree resources to change characteristics of the first clock tree, wherein: the global clock circuitry is formed using the horizontal routing tracks and the vertical routing tracks, wherein at least one pair of the horizontal routing tracks located on horizontal IC interface circuitries or the vertical routing tracks located on vertical IC interface circuitries of at least two adjacent ICs of the plurality of ICs are tied together, the global clock circuitry configured to route the clock signal to each of the plurality of ICs.
